(19) United States
(12) Patent Application Publication
(10) Pub. No.: US 2025/0249795 A1
(43) Pub. Date: Aug. 7, 2025

(54) ELECTRIC ACTUATOR FOR VEHICLE SEAT

(71) Applicant: TOYOTA BOSHOKU KABUSHIKI KAISHA, Aichi (JP)

(72) Inventors: Tatsuki NIWA, Toyota-shi (JP); Fumiya YAMAMOTO, Toyota-shi (JP); Masayuki KANEHIRA, Gifu-shi (JP)

(73) Assignee: TOYOTA BOSHOKU KABUSHIKI KAISHA, Aichi (JP)

(21) Appl. No.: 19/043,968

(22) Filed: Feb. 3, 2025

(30) Foreign Application Priority Data
Feb. 6, 2024 (JP) 2024-016326

(51) Int. Cl. B60N 2/02; B60N 2/06; H02K 7/116

(52) U.S. Cl. CPC B60N 2/02253; B60N 2/06; H02K 7/1166

(57) ABSTRACT

An electric actuator of the present disclosure includes an electric motor, a shaft, and a gear, and further includes a radial bearing supporting the shaft, a thrust bearing restricting a displacement of the shaft, a housing including a housing portion that houses the thrust bearing, and a cap inserted in the housing portion. The cap has a cylindrical shape and restricts a rotation of the thrust bearing. A slanting surface is provided to at least one of a leading end in an insertion direction of an outer circumferential engagement portion of the cap or a part adjacent to the insertion port in an engagement target portion. The slanting surface is configured to generate a rotational force that rotates the cap in a specific direction as the cap is inserted in the housing portion.

### CROSS-REFERENCE TO RELATED APPLICATIONS

The present disclosure claims the benefit of Japanese Patent Application No. 2024-016326 filed on Feb. 6, 2024 with the Japan Patent Office, the disclosure of which is incorporated herein in its entirety by reference.

### BACKGROUND

The present disclosure relates to an electric actuator configured to be applied to a vehicle seat.

An electric vehicle seat comprises an electric actuator as a drive source to displace a part of the seat. The electric actuator includes an electric motor, a shaft configured to be rotatably driven by the electric motor, a gear fixed to the shaft, and the like.

In the shaft, there is a case where rattles occur along an axial direction during a rotation of the shaft. In order to suppress a noise caused by rattling, for example, Japanese Unexamined Patent Application Publication No. 2001-330027 (Patent Document 1) discloses a configuration in which a position of a thrust bearing is adjustable with an adjustment screw.

### SUMMARY

However, in the invention disclosed in Patent Document 1, there is a need to increase a fastening torque of the adjustment screw so as to prevent loosening of the adjustment screw. As a result, a contact surface pressure between the shaft and the thrust bearing becomes excessively high, posing a possibility in which a significant drive power loss occurs in a contact part between the shaft and the thrust bearing. The present disclosure provides one example of the electric actuator in view of the above point.

It is preferable that an electric actuator configured to be applied to a vehicle seat and including an electric motor, a shaft rotatably driven by the electric motor, and a gear fixed to the shaft comprises, for example, at least one of the following constituent elements.

Specifically, the constituent elements are a radial bearing, a thrust bearing, a housing, and a cap. The radial bearing contacts an outer circumferential surface of the shaft, to thereby rotatably support the shaft. The thrust bearing contacts an end of the shaft in a direction along a rotation center axis, to thereby restrict a displacement of the shaft in the direction along the rotation center axis as a center axis. The thrust bearing is provided with a male screw portion in the form of a spiral around the rotation center axis. The housing includes a housing portion that houses at least the thrust bearing. The housing is provided with a female screw portion threadedly engaged with the male screw portion. The cap is inserted into the housing portion from an insertion port. The cap has a cylindrical shape. The cap restricts a rotation of the thrust bearing about the rotation center axis. The cap is provided with, on an outer circumferential surface thereof, an outer circumferential engagement portion engaged with an engagement target portion provided to an inner circumferential surface of the housing. The cap is provided with, on an inner circumferential surface thereof, an inner circumferential engagement portion engaged with the thrust bearing.

Preferably, a slanting surface is provided to at least one of a leading end of the outer circumferential engagement portion in an insertion direction of the cap or a part of the engagement target portion adjacent to the insertion port. The slanting surface slants to an imaginary line parallel to the rotation center axis. The slanting surface is configured to generate a rotational force that rotates the cap in a specific direction about the rotation center axis as the center axis as the cap is inserted along the rotation center axis.

Due to the above configuration, the thrust bearing of the electric actuator is prevented from being displaced in a manner to come closer to or move apart from the shaft as long as the thrust bearing is prevented from rotating about the rotation center axis.

Moreover, since the thrust bearing undergoes a restriction so as not to rotate due to the cap, the thrust bearing is prevented from being displaced in a manner to come closer to or move apart from the shaft. Therefore, in the electric actuator, there is no need to excessively increase a fastening torque of the thrust bearing with respect to the housing.

Consequently, a contact surface pressure between the shaft and the thrust bearing is inhibited from increasing excessively; therefore, a significant drive power loss can be inhibited from occurring in a contact part between the shaft and the thrust bearing.

In order to improve ease of insertion in inserting the cap into the housing portion, it is preferable that a tapered surface is provided to at least one of the leading end of the outer circumferential engagement portion in the insertion direction or the part of the engagement target portion adjacent to the insertion port.

Specifically, if the tapered surface is provided, the outer circumferential engagement portion is guided to the engagement target portion as the cap is inserted. However, if the tapered surface is provided, there is a possibility that the cap rotates with respect to the housing as being housed in the housing portion.

As the cap rotates with respect to the housing, the thrust bearing is displaced in the direction along the rotation center axis in association with the rotation of the cap. At this time, in a case where a rotation direction of the cap is a clockwise direction, for example, there is a possibility that the contact surface pressure between the shaft and the thrust bearing increases excessively.

In a case where the rotation direction of the cap is a counterclockwise direction, for example, there is a possibility that the thrust bearing is spaced apart from the shaft. As stated above, a relation between the thrust bearing and the shaft changes significantly depending on the rotation direction of the cap.

In contrast, the slanting surface of the electric actuator is configured to generate the rotational force that rotates the cap in the specific direction as the cap is inserted.

Due to the above configuration, even if the cap rotates and the relation between the thrust bearing and the shaft changes as the cap is inserted, such a change remains within what is expected in advance during a designing process. Therefore, the electric actuator can ensure that performance thereof falls within what is expected in advance during the designing process.

It should be noted that the electric actuator may have a configuration below, for example.

Specifically, it is preferable that the slanting surface slants to the imaginary line so as to generate a rotational force in a direction to loosen a threaded engagement between the male screw portion and the female screw portion when the leading end of the outer circumferential engagement portion in the insertion direction and the part of the engagement target portion adjacent to the insertion port contact each other.

Due to the above configuration, the electric actuator can ensure that the contact surface pressure between the shaft and the thrust bearing is inhibited from increasing excessively, which can therefore ensure that a significant drive power loss is inhibited from occurring in the contact part between the shaft and the thrust bearing.

Furthermore, it is preferable that the outer circumferential engagement portion and the engagement target portion are configured in the form of a serration or a spline including two or more elongated protrusions extending in a direction parallel to the rotation center axis. Moreover, there is preferably provided a configuration in which the slanting surface is provided to an end in an extending direction of each elongated protrusion; between lengths in the extending direction of the each elongated protrusion, a first length at a first end in a width direction is longer than a second length at a second end in the width direction; and a direction from the first end in the width direction towards the second end in the width direction corresponds to a load direction.

It should be noted that a rotational direction of the shaft, at a time when the contact surface pressure between the shaft and the thrust bearing increases, is a forward direction. The load direction means the forward direction projected onto an imaginary plane containing the rotation center axis. The width direction means a direction orthogonal to the extending direction of the each elongated protrusion.

In the electric actuator according to the above configuration, as the shaft rotates in the forward direction, a rotational force in the forward direction acts on the thrust bearing and the cap. Then, the each elongated protrusion receives the rotational force.

In the electric actuator, between the lengths in the extending direction of the each elongated protrusion provided to the cap, the first length at the first end in the width direction is longer than the second length at the second end in the width direction, and the direction from the first end in the width direction towards the second end in the width direction corresponds to the load direction.

In other words, the electric actuator is configured so that the rotational force is received at the first end in the width direction of the each elongated protrusion. Therefore, since a part to receive the rotational force has a greater area, the performance of the electric actuator is stable, as compared with a configuration in which the rotational force is received at the second end in the width direction of the each elongated protrusion.

Still further, it is preferable that the electric actuator further comprises a rotation restrictor and a restrictive engagement portion. The rotation restrictor is provided to the inner circumferential engagement portion and restricts the rotation of the thrust bearing with respect to the cap about the rotation center axis. The restrictive engagement portion is provided to the thrust bearing and engaged with the rotation restrictor. The restrictive engagement portion is provided in an area from the male screw portion to a non-contact end. Preferably, the non-contact end of the thrust bearing is located outside the housing.

It should be noted that the thrust bearing has a contact end that contacts the shaft. The non-contact end is an end part of the thrust bearing opposite to the contact end in the direction along the rotation center axis.

Due to the above configuration, when an assembly in which the cap is fixed intermediately to the thrust bearing is assembled to the housing in a case, for example, where an assembly operator assembles the electric actuator, the rotation restrictor is engaged with the restrictive engagement portion prior to an engagement between the outer circumferential engagement portion and the engagement target portion.

Still further, it is preferable that the electric actuator further comprises a protrusion and a fitting part. The protrusion is provided to a part of the inner circumferential surface of the cap adjacent to the contact end. The fitting part is provided to a part of the thrust bearing adjacent to the non-contact end. The fitting part allows the protrusion to be fitted in and engaged with the fitting part. Preferably, in a state where the protrusion is fitted in the fitting part and the contact end of the thrust bearing and the shaft contact each other, the outer circumferential engagement portion and the engagement target portion are in a non-engaged state.

Due to the above configuration, the cap is fixed intermediately to the thrust bearing at a position that prevents the outer circumferential engagement portion from interfering with the engagement target portion until the threaded engagement completes between the male screw portion of the thrust bearing and the female screw portion of the housing.

### BRIEF DESCRIPTION OF THE DRAWINGS

Example embodiments of the present disclosure will be described hereinafter with reference to the accompanying drawings, in which:

FIG. 1 is a diagram illustrating a vehicle seat according to a first embodiment;

FIG. 2 is an exploded view of an electric actuator according to the first embodiment;

FIG. 3 is a diagram illustrating a structure of the electric actuator according to the first embodiment;

FIG. 4 is a diagram illustrating the structure of the electric actuator according to the first embodiment;

FIG. 5 is a diagram illustrating a thrust bearing according to the first embodiment;

FIG. 6 shows a diagram illustrating a bearing holder according to the first embodiment;

FIG. 7 is a diagram illustrating a structure of a housing according to the first embodiment;

FIG. 8 is a diagram illustrating a cap according to the first embodiment;

FIG. 9 is a diagram illustrating structures of an outer circumferential engagement portion and an engagement target portion according to the first embodiment;

FIG. 10 is a diagram illustrating an elongated protrusion according to the first embodiment;

FIG. 11 is a diagram illustrating the cap according to the first embodiment;

FIG. 12 is a diagram illustrating fitting between the cap and the thrust bearing according to the first embodiment;

FIG. 13 is a diagram illustrating an intermediate assembly; and

FIG. 14 is a diagram illustrating the structure of the electric actuator according to the first embodiment.

### DETAILED DESCRIPTION OF EXEMPLARY EMBODIMENTS

In the present embodiment, a description is given to an electric actuator configured to be used in a vehicle seat mounted on a vehicle such as an automobile.

“Embodiments” below show examples of embodiments within the technical scope of the present disclosure. In other words, invention-specifying matters and the like recited in the claims are not limited to specific configurations, structures, or the like in the below-described embodiments.

Arrows indicating directions, hatched lines, and the like in the drawings are provided for easy understanding of the mutual relations between the drawings, and shapes and the like of members or portions in the drawings.

Therefore, the present disclosure is not limited to directions provided in the drawings. Directions in the drawings are defined in relation to the electric actuator according to the present embodiment that is assembled to the vehicle. Drawings including the hatched lines do not necessarily show cross-section views.

A member or a portion described at least with a reference numeral is at least one in number except in a case of being accompanied by restrictive words such as “only one”. In other words, there may be two or more of such a member when the number is not specified as “only one of” and the like.

The electric actuator provided in the present disclosure comprises at least one of a constituent element such as a member or a portion described at least with a reference numeral, or a structural part illustrated.

### First Embodiment

### <1. Overview of Vehicle Seat>

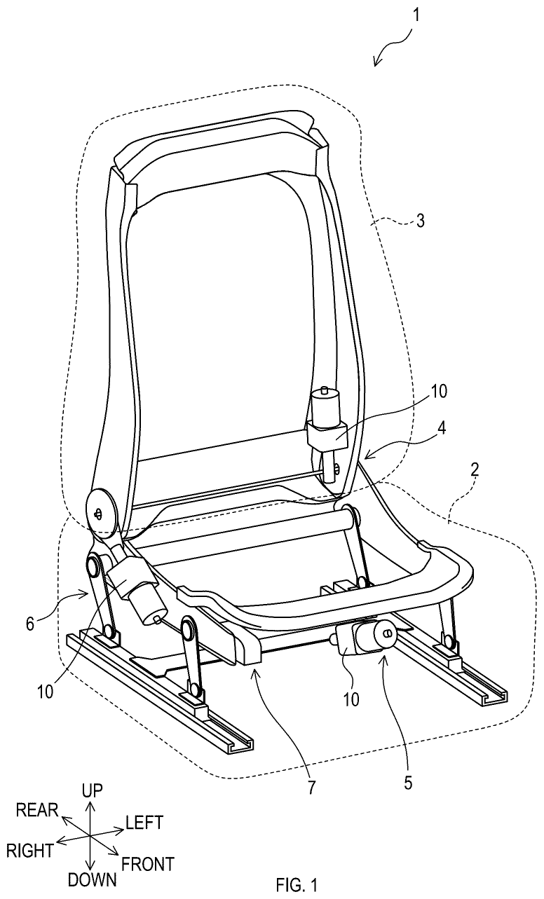

As illustrated in FIG. 1, a vehicle seat 1 comprises at least one of a recliner 4, a sliding device 5, a lifting device 6, or a tilting device 7, in addition to a seat cushion 2 and a seatback 3.

The seat cushion 2 is a part to support buttocks of an occupant. The seatback 3 is a part to support the back of the occupant. The seatback 3 is pivotably coupled to a rear end of the seat cushion 2.

The recliner 4 is a movable mechanism to swing the seatback 3 in seat front-rear directions on a lower end of the seatback 3. The sliding device 5 is a movable mechanism to slidably displace the seat cushion 2 in the seat front-rear directions.

The lifting device 6 is a movable mechanism to move the seat cushion 2 upwards and downwards. The tilting device 7 is a movable mechanism to swing a front end of the seat cushion 2 upwards and downwards. Each of the recliner 4, the sliding device 5, the lifting device 6, and the tilting device 7 operates with an electric actuator 10 as a drive source thereof.

### <2. Configuration of Electric Actuator>

### <2.1 Overview of Configuration>

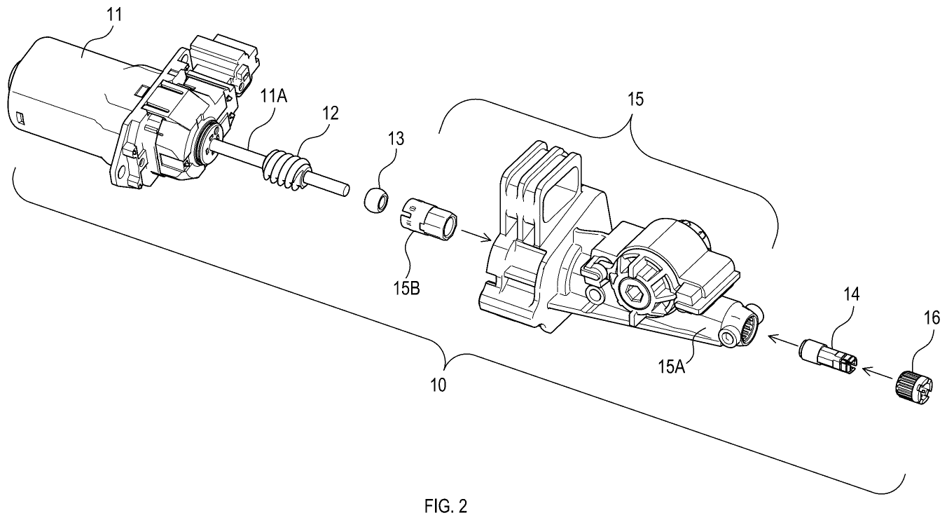

As illustrated in FIG. 2, the electric actuator 10 comprises an electric motor 11, a shaft 11A, a gear 12, a radial bearing 13, a thrust bearing 14, a housing 15, and a cap 16.

### <Shaft and Gear>

The shaft 11A is rotatably driven by the electric motor 11. The electric motor 11 is a motor of the inner rotor type whose rotor (now shown) rotates inside the motor. The shaft 11A is directly connected to the rotor.

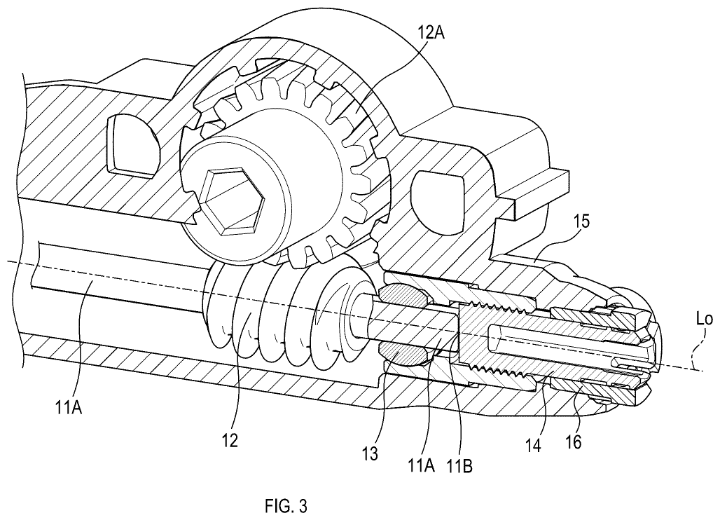

The gear 12 is fixed to the shaft 11A, and rotates integrally with the shaft 11A. The gear 12 comprises a worm (see, FIGS. 2 and 3). The gear 12 meshes a worm wheel which forms an output gear 12A (see, FIG. 3).

Since the gear 12 comprises the worm, the shaft 11A bears a load in a thrust direction and a load in a radial direction when a force is applied to the gear 12. The thrust direction is a direction parallel to a rotation center axis Lo of the shaft 11A. The radial direction is a direction orthogonal to the thrust direction.

### <Bearing>

The radial bearing 13 contacts an outer circumferential surface of the shaft 11A, to thereby rotatably support the shaft 11A. The radial bearing 13 is, for example, a slide bearing that slidably contacts the outer circumferential surface of the shaft 11A. Specifically, the radial bearing 13 is a bush made of sintered metal.

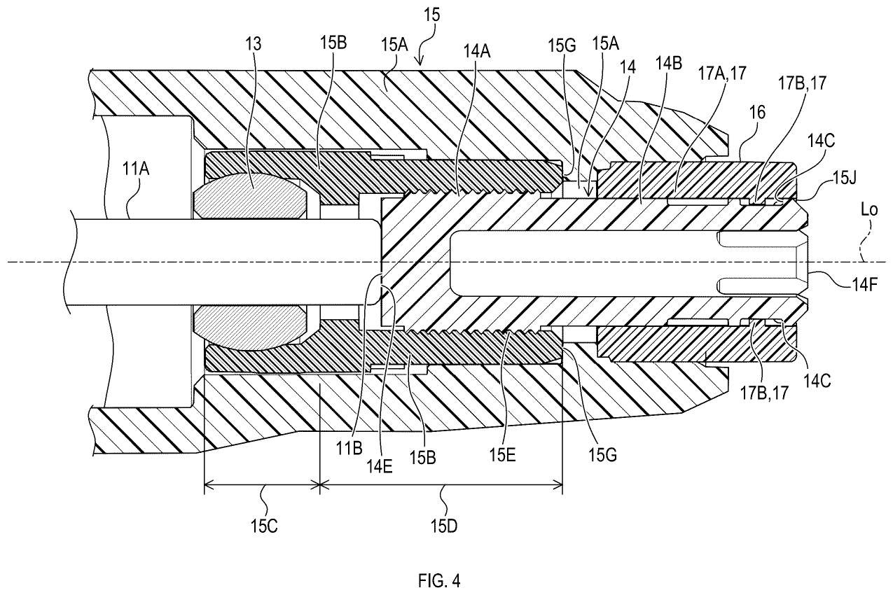

As illustrated in FIG. 4, the thrust bearing 14 contacts a longitudinal end 11B of the shaft 11A. Thus, the thrust bearing 14 comprises a guide to restrict a displacement of the shaft 11A in a direction along the rotation center axis Lo.

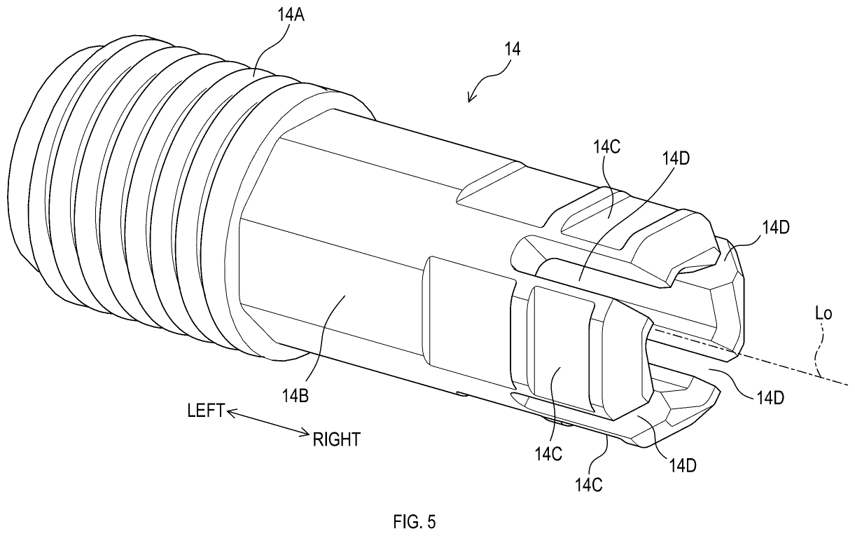

As illustrated in FIG. 5, the thrust bearing 14 is provided with a male screw portion 14A. The male screw portion 14A comprises a protrusion in the form of a spiral around the rotation center axis Lo as a center axis. The thrust bearing 14 is a slide bearing made of resin.

### <Housing>

As illustrated in FIG. 4, the housing 15 is a casing including a housing portion 15A that houses at least the thrust bearing 14. The housing 15 includes a housing body 15A and a bearing holder 15B. Both of the housing body 15A and the bearing holder 15B may be made of resin.

The housing portion 15A is formed in the housing body 15A. The bearing holder 15B is inserted into and fixed to the housing body 15A while holding the radial bearing 13. Specifically, the bearing holder 15B is provided with a holder 15C and a rotation stopper 15D.

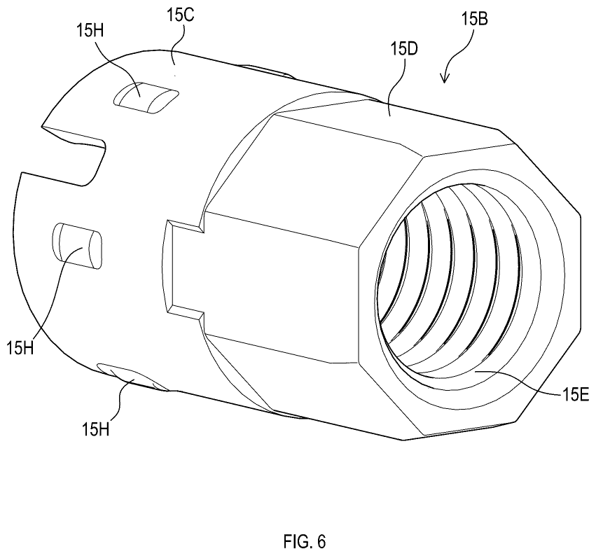

The holder 15C is a part provided with a fitting hole in which the radial bearing 13 is fitted. As illustrated in FIG. 6, the rotation stopper 15D is a part formed into a cylindrical shape, provided with a polygonal rotation stopper in an outer circumferential part thereof, and provided with a female screw portion 15E in an inner circumferential part thereof.

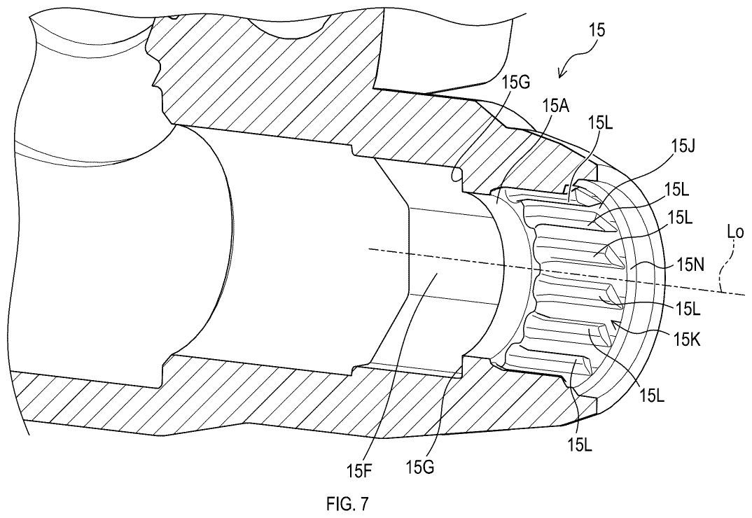

As illustrated in FIG. 4, the female screw portion 15E is threadedly engaged with the male screw portion 14A of the thrust bearing 14. As illustrated in FIG. 7, the housing body 15A is provided with a polygonal hole 15F having a shape that substantially matches an outer circumferential shape of the rotation stopper 15D.

The rotation stopper 15D of the bearing holder 15B and the polygonal hole 15F of the housing body 15A are engaged. This prevents the bearing holder 15B from rotating about the rotation center axis Lo with respect to the housing body 15A.

The housing body 15A is provided with a stepped portion 15G, which forms the stopper. A longitudinal end of the bearing holder 15B contacts the stepped portion 15G (see, FIG. 4), whereby a position of the bearing holder 15B in a direction parallel to the rotation center axis Lo is set. The bearing holder 15B may be press-fitted in and fixed to the housing body 15A.

The press-fit means, for example, a transition fit or an interference fit in which an interference is greater than zero. An outer circumferential surface of the holder 15C is provided with a compression seal 15H in the form of a protrusion (see, FIG. 6). The compression seal 15H can achieve a state where the interference is greater than zero.

### <Cap>

As illustrated in FIG. 4, the cap 16 is a cylindrical member to restrict a rotation of the thrust bearing 14 about the rotation center axis Lo. The cap 16 is inserted from an insertion port 15J of the housing portion 15A and fitted in the housing portion 15A.

### <2.2 Fitting Structure of Cap>

<Connecting Structure between Cap and Housing Portion (Housing)>

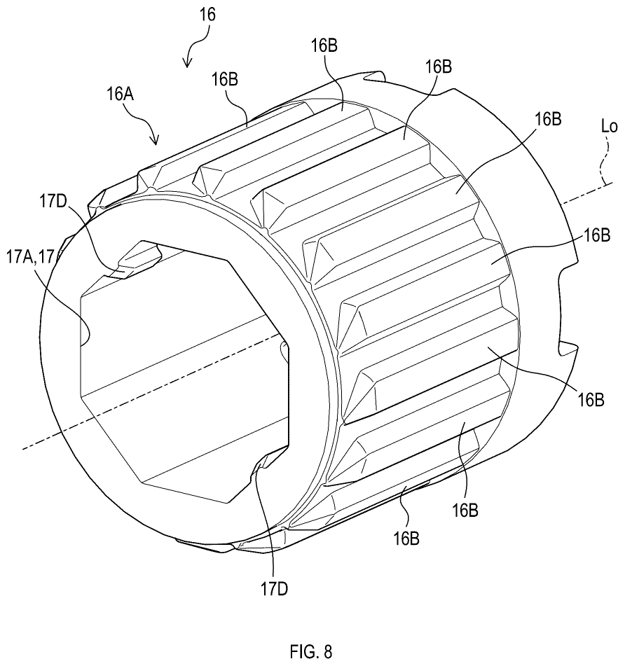

As illustrated in FIG. 8, an outer circumferential surface of the cap 16 is provided with an outer circumferential engagement portion 16A. As illustrated in FIG. 7, an inner circumferential surface of the housing portion 15A is provided with an engagement target portion 15K to be engaged with the outer circumferential engagement portion 16A.

The outer circumferential engagement portion 16A and the engagement target portion 15K are engaged with each other (see, FIG. 4), whereby the cap 16 is prevented from rotating about the rotation center axis Lo with respect to the housing body 15A.

As illustrated in FIGS. 7 and 8, the outer circumferential engagement portion 16A and the engagement target portion 15K, respectively, are configured in the form of a serration or a spline that includes two or more elongated protrusions 16B and 15L extending in the direction parallel to the rotation center axis Lo.

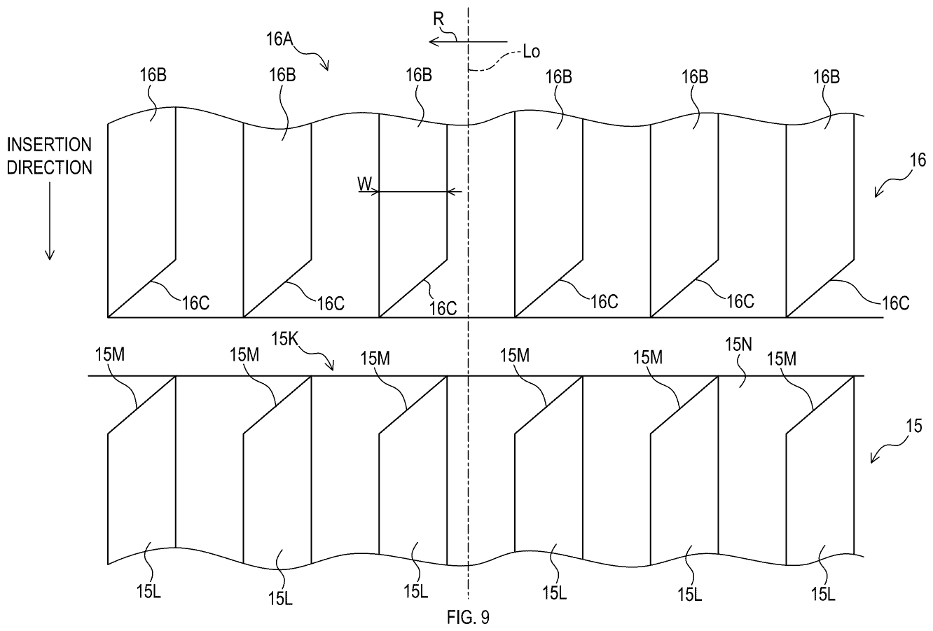

As illustrated in FIG. 9, there is provided a slanting surface 16C in a leading end of the outer circumferential engagement portion 16A in an insertion direction of the cap; and there is provided a slanting surface 15M in a part of the engagement target portion 15K adjacent to the insertion port 15N. Each slanting surface 16C and 15M is a surface that slants to an imaginary line parallel to the rotation center axis Lo.

FIG. 9 is a developed view presenting a projection of each slanting surface 16C and 15M onto an inner circumferential surface of an imaginary cylinder that is arranged around outer circumferences of the cap 16 and the housing portion 15A. Thus, left-right directions in FIG. 9 correspond to circumferential directions of the cap 16 and the housing portion 15A.

In other words, the slanting surface 16C is provided to the leading end in the insertion direction of each elongated protrusion 16B. The slanting surface 15M is provided to the part of each elongated protrusion 15L adjacent to the insertion port 15N.

Each slanting surface 16C and 15M slants so as to generate a rotational force that rotates the cap 16 in a specific direction about the rotation center axis Lo as a center axis as the cap 16 is inserted along the rotation center axis Lo.

Reference is made to FIG. 9. When the cap 16 is displaced towards the housing 15 along the rotation center axis Lo and each slanting surface 16C and each slanting surface 15M contact each other, the slanting surface 16C slides with respect to the slanting surface 15M. Consequently, the cap 16 rotates in a direction along the allow R in FIG. 9.

Each slanting surface 16C and 15M slants so as to generate a rotational force in a direction to loosen the threaded engagement between the male screw portion 14A and the female screw portion 15E as each slanting surface 16C and the corresponding slanting surface 15M contact and slide with respect to each other.

When the cap 16 is inserted, its maximum rotational angle is a rotational angle equivalent to a width W of the elongated protrusion 16B. In the present embodiment, the cap 16 is configured so that its maximum rotational angle at the time when the cap 16 is inserted in the housing portion 15A is approximately 60 degrees or less.

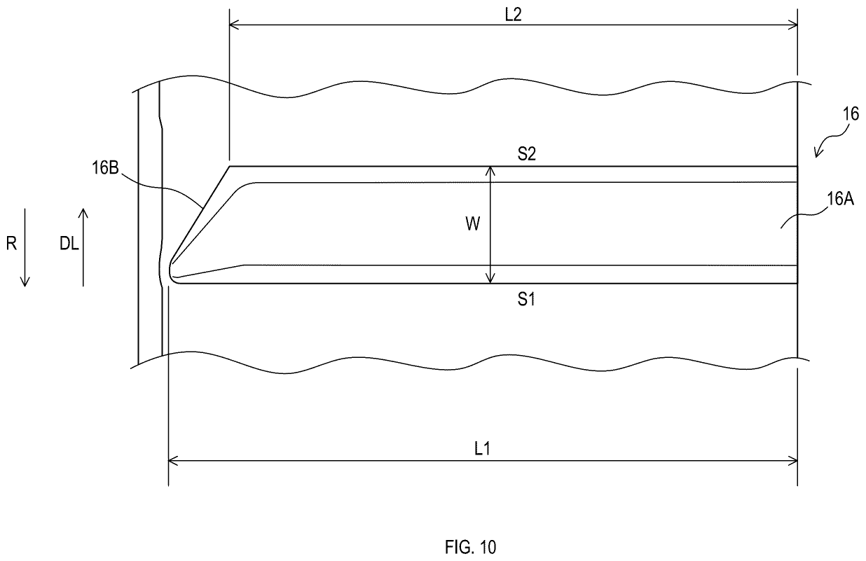

As illustrated in FIG. 10, at least the elongated protrusion 16B provided to the cap 16 has a first side S1 in a width W-direction thereof whose length L1 is longer than a length L2 of a second side S2. In the width W-direction, a direction from the first side S1 towards the second side S2 corresponds to a load direction DL.

The lengths L1 and L2 are lengths in an extending direction of the elongated protrusion 16B. The width W-direction of the elongated protrusion 16B is orthogonal to the extending direction of the elongated protrusion 16B. The load direction DL is a forward direction projected onto an imaginary plane that contains the rotation center axis Lo and is parallel to the paper of FIG. 10.

The forward direction means a rotational direction of the shaft 11A during a time when a contact surface pressure between the shaft 11A and the thrust bearing 14 increases. In FIG. 9, the forward direction is an opposite direction to the arrow R. Each elongated protrusion 15L has a similar shape to the elongated protrusion 16B.

<Connecting Structure between Cap and Thrust Bearing>

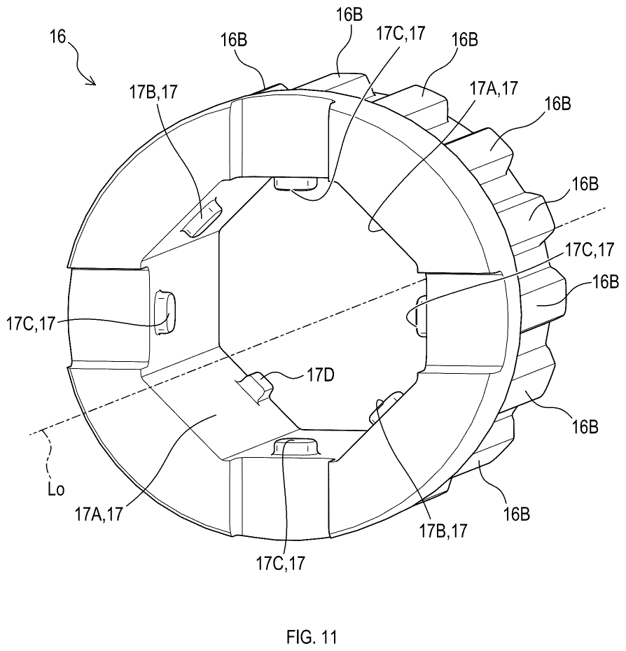

As illustrated in FIG. 11, there is provided an inner circumferential engagement portion 17 on an inner circumferential surface of the cap 16. The inner circumferential engagement portion 17 is a portion to be engaged with the thrust bearing 14, and exerts at least two functions.

The first function is to restrict a rotation of the thrust bearing 14 with respect to the cap 16 about the rotation center axis Lo. The second function is to restrict a displacement of the thrust bearing 14 with respect to the cap 16 in the direction parallel to the rotation center axis Lo.

Specifically, the inner circumferential engagement portion 17 includes a first engagement portion 17A, and a second engagement protrusion 17B and a third engagement protrusion 17C. The first engagement portion 17A and the third engagement protrusion 17C predominantly carry the first function. The second engagement protrusion 17B predominantly carries the second function.

### <Details of First Function>

The first engagement portion 17A is one example of the rotation restrictor that restricts the rotation of the thrust bearing 14 with respect to the cap 16 about the rotation center axis Lo. Specifically, the first engagement portion 17A is a polygonal (an octagon, in the present embodiment) fitting hole.

Thus, the thrust bearing 14 is provided with a first engagement target portion 14B (see, FIG. 5) to be engaged with the first engagement portion 17A. The first engagement target portion 14B is one example of the restrictive engagement portion. The first engagement target portion 14B comprises a polygonal (an octagon, in the present embodiment) shaft that is fitted in the fitting hole, which forms the first engagement portion 17A.

As illustrated in FIG. 5, there is provided at least one slit 14D (two or more, in the present embodiment) at an end of the longitudinal ends of the thrust bearing 14 opposite to the male screw portion 14A (a right end-side in FIG. 5). The slit 14D is a groove extending in the direction parallel to the rotation center axis Lo.

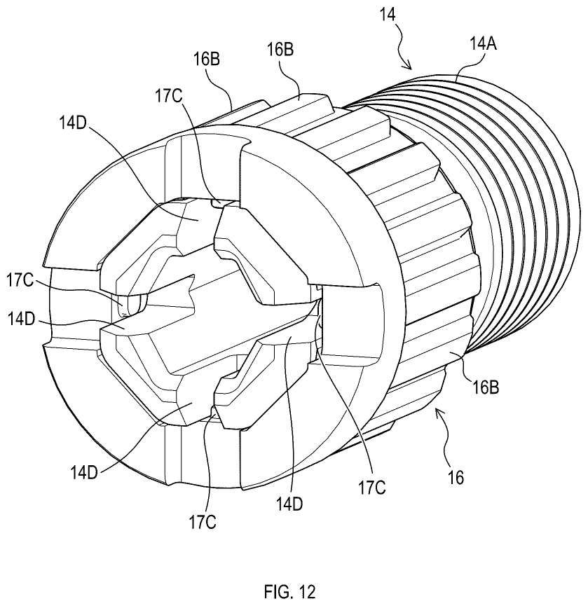

The third engagement protrusion 17C provided to the inner circumferential surface of the cap 16 is, as illustrated in FIG. 12, fitted in each slit 14D. This restricts the rotation of the thrust bearing 14 with respect to the cap 16 about the rotation center axis Lo.

Each third engagement protrusion 17C is slidably displaced in a state of being fitted in the corresponding slit 14D as the outer circumferential engagement portion 16A is engaged with the engagement target portion 15K. Since the thrust bearing 14 is provided with the slit 14D, the above right end-side of the thrust bearing 14 is easily deformed in a tapered manner as the cap 16 is attached to the thrust bearing 14. Consequently, an operator can easily attach the cap 16 to the thrust bearing 14.

### <Details of Second Function>

The second engagement protrusion 17B restricts the displacement of the thrust bearing 14 with respect to the cap 16 in the direction parallel to the rotation center axis Lo. Specifically, the second engagement protrusion 17B comprises at least one (two, in the present embodiment) protrusion protruding from the inner circumferential surface of the cap 16 towards the rotation center axis Lo.

As illustrated in FIG. 5, an outer circumferential surface of the thrust bearing 14 is provided with a second engagement target portion 14C, which is one example of the fitting part. The second engagement target portion 14C is provided at the end of the longitudinal ends of the thrust bearing 14 opposite (on the right end-side in FIG. 5) to the male screw portion 14A, a position facing the second engagement protrusion 17B.

Each of the second engagement target portion 14C and the second engagement protrusion 17B is two or more in number (four, in the present embodiment). As illustrated in FIG. 4, each second engagement target portion 14C is engaged with the corresponding second engagement protrusion 17B.

Specifically, each second engagement target portion 14C is a groove-like portion (see, FIG. 5) in which the corresponding and opposing second engagement protrusion 17B can be fitted, and that extends in a direction orthogonal to the rotation center axis Lo.

Thus, in a state where the second engagement protrusion 17B facing each second engagement target portion 14C is fitted, the cap 16 (or the thrust bearing 14) undergoes a restriction so as not to be displaced by a distance greater than a specific distance in the direction parallel to the rotation center axis Lo, as illustrated in FIG. 4.

### <Structure of Fixing Cap Intermediately to Thrust Bearing>

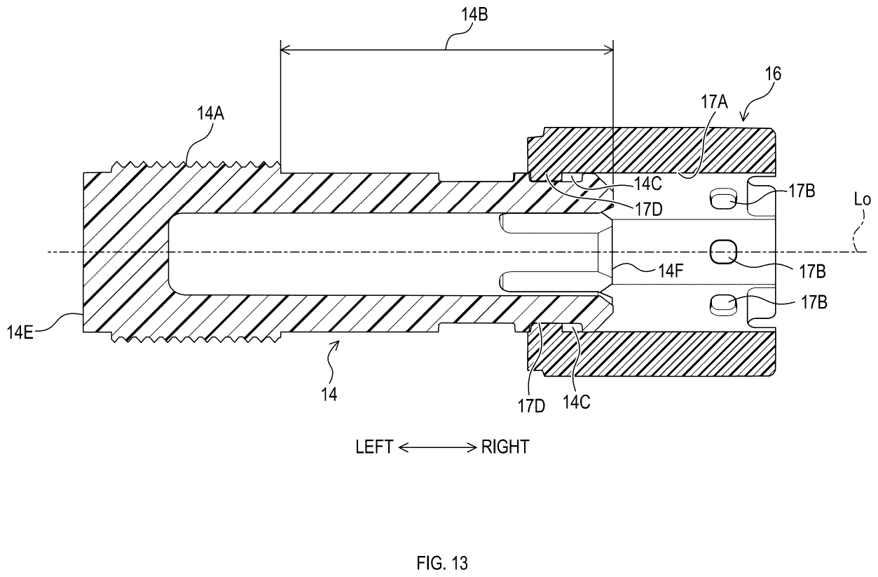

In the electric actuator 10, the thrust bearing 14 and the cap 16 are assembled to the housing 15 as an intermediate assembly illustrated in FIG. 13.

The intermediate assembly is formed by fixing the cap 16 intermediately at a specific position in the thrust bearing 14. As illustrated in FIG. 8, an inner circumferential surface of the fitting hole, which forms the first engagement portion 17A, is provided with a protrusion 17D.

The protrusion 17D locates the cap 16 so as to fix the same intermediately at the specific position in the thrust bearing 14 as being fitted in the second engagement target portion 14C of the thrust bearing 14. The specific position is, for example, a position that satisfies the following requirements (a) and (b).

The requirement (a) is that the cap 16 and the thrust bearing 14 are assembled to the housing 15 in a state where they are integrally assembled in advance, that is, they form the intermediate assembly.

The requirement (b) is that until the threaded engagement completes between the male screw portion 14A of the thrust bearing 14 and the female screw portion 15E of the housing 15, the cap 16 is fixed intermediately to the thrust bearing 14 at a position that prevents the outer circumferential engagement portion 16A from interfering with the engagement target portion 15K.

Specifically, the above requirements (a) and (b) are as follows.

As illustrated in FIG. 13, the second engagement target portion 14C is provided closer to a non-contact end 14F. The protrusion 17D is provided in the cap 16, closer to a contact end 14E (the left side) than the second engagement protrusion 17B is, at a position that allows the protrusion 17D to be fitted in and engaged with the second engagement target portion 14C.

The contact end 14E is a part of the thrust bearing 14 contacting the shaft 11A. The non-contact end 14F is an end part of the thrust bearing 14 opposite to the contact end 14E in the rotation center axis Lo. In FIG. 13, the contact end 14E is on the left side; and the non-contact end 14F is on the right side.

In a state where the protrusion 17D is fitted in the second engagement target portion 14C, as illustrated in FIG. 13, the first engagement portion 17A and the first engagement target portion 14B are engaged, and the second engagement protrusion 17B and the second engagement target portion 14C are in a non-engaged state.

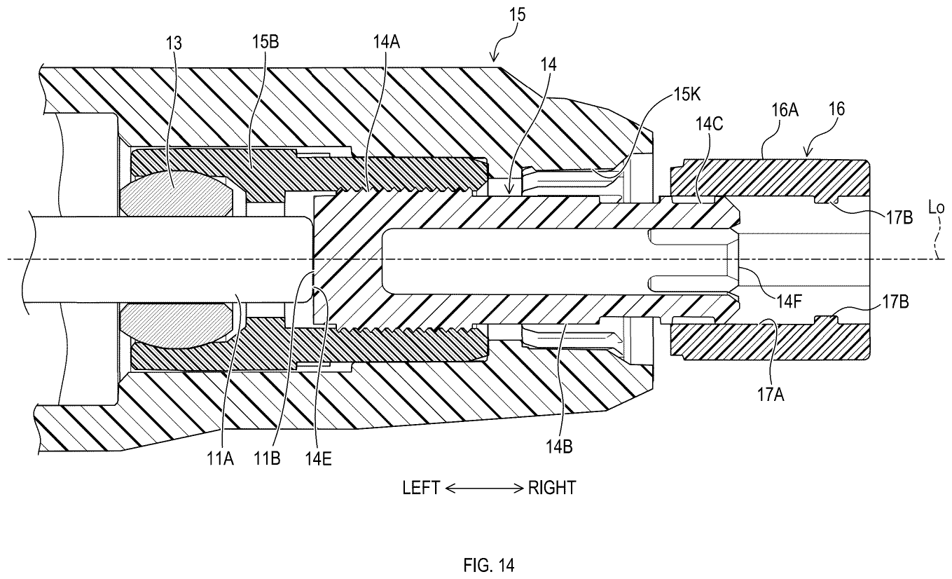

Moreover, in a state where the protrusion 17D is fitted in the second engagement target portion 14C and the contact end 14E of the thrust bearing 14 and the longitudinal end 11B of the shaft 11A contact each other, the outer circumferential engagement portion 16A and the engagement target portion 15K are in a non-engaged state as illustrated in FIG. 14.

In a state where the second engagement protrusion 17B is fitted in the second engagement target portion 14C, that is, an assembly of the cap 16 and the thrust bearing 14 completes with respect to the housing 15, the outer circumferential engagement portion 16A and the engagement target portion 15K are engaged; the inner circumferential engagement portion 17 and the thrust bearing 14 are engaged; and the protrusion 17D is depressed and contacts the first engagement target portion 14B.

### <Engagement Relation for Restriction on Rotation of Thrust Bearing>

The outer circumferential engagement portion 16A, the first engagement portion 17A, the first engagement target portion 14B, and the engagement target portion 15K are situated at positions that satisfy the following requirement (c).

The requirement (c) is that when the intermediate assembly is assembled to the housing 15, the first engagement portion 17A is engaged with the first engagement target portion 14B prior to an engagement of the outer circumferential engagement portion 16A with respect to the engagement target portion 15K.

Specifically, the first engagement target portion 14B is, as illustrated in FIG. 13, spreads over an area from the male screw portion 14A to the non-contact end 14F. In a state where the thrust bearing 14 is mounted to the housing 15, the non-contact end 14F (the second engagement target portion 14C, in the present embodiment) of the thrust bearing 14 is located outside the housing 15 as illustrated in FIG. 4.

Thus, in the state where the protrusion 17D is fitted in the second engagement target portion 14C, the first engagement portion 17A is engaged with the first engagement target portion 14B, and the outer circumferential engagement portion 16A is in the non-engaged state with respect to the engagement target portion 15K as illustrated in FIG. 14. Accordingly, the present embodiment provides a configuration satisfying the requirement (c).

<2.2 Method of Mounting Thrust Bearing and Cap (see, FIG. 2)>

In the housing 15 in which the electric motor 11 is installed, the operator (including an automatic assembly machine) mounts the intermediate assembly formed such that the protrusion 17D is fitted in the second engagement target portion 14C.

In other words, in the intermediate assembly, the cap 16 is fixed intermediately to the thrust bearing 14 at the position that prevents the outer circumferential engagement portion 16A from interfering with the engagement target portion 15K until the threaded engagement completes between the male screw portion 14A of the thrust bearing 14 and the female screw portion 15E of the housing 15.

Subsequently, the operator fastens the male screw portion 14A of the thrust bearing 14 to the female screw portion 15E of the housing 15 while the electric motor 11 is powered to thereby rotate the shaft 11A. Since the first engagement portion 17A and the first engagement target portion 14B are engaged, the operator can fasten the male screw portion 14A to the female screw portion 15E by rotating the cap 16.

Then, the operator stops a rotation of the thrust bearing 14 to thereby finish a fastening work for the thrust bearing 14 upon an electric current value of the electric motor 11 exceeding a specific threshold value (hereinafter, “fastening stop current value”).

At the time of finish of the fastening work, the first engagement portion 17A is engaged with the first engagement target portion 14B, and the outer circumferential engagement portion 16A is not engaged with the engagement target portion 15K. In other words, in the present embodiment, the first engagement portion 17A is engaged with the first engagement target portion 14B prior to the engagement of the outer circumferential engagement portion 16A with respect to the engagement target portion 15K.

Subsequently, the operator brings the outer circumferential engagement portion 16A of the cap 16 into the engagement with the engagement target portion 15K of the housing 15, and inserts and fits the cap 16 into the housing 15 so that each third engagement protrusion 17C of the cap 16 is fitted in the corresponding slit 14D.

<3. Features of Electric Actuator according to Present Embodiment>

In the present embodiment, since each elongated protrusion 16B is engaged with the corresponding elongated protrusion 15L, the thrust bearing 14 is prevented from being displaced in a manner to come closer to or move apart from the shaft 11A as long as the thrust bearing 14 is prevented from rotating about the rotation center axis Lo.

Moreover, since the thrust bearing 14 undergoes the restriction so as not to rotate due to the cap 16, the thrust bearing 14 is prevented from being displaced in a manner to come closer to or move apart from the shaft 11A. Therefore, in the present embodiment, there is no need to excessively increase a fastening torque of the thrust bearing 14 with respect to the housing 15.

Consequently, the contact surface pressure between the shaft 11A and the thrust bearing 14 is inhibited from increasing excessively; therefore, a significant drive power loss can be inhibited from occurring in a contact part between the shaft 11A and the thrust bearing 14.

In order to improve ease of insertion in inserting the cap 16 into the housing portion 15A, it is preferable that each elongated protrusion 16B and 15L is provided with a tapered surface for guiding. However, if the tapered surface is provided, there is a possibility that the cap 16 rotates with respect to the housing 15 as being housed in the housing 15.

As the cap 16 rotates with respect to the housing 15, the thrust bearing 14 is displaced in the direction along the rotation center axis in association with the rotation of the cap 16. At this time, in a case where a rotation direction of the cap 16 is a clockwise direction, for example, there is a possibility that the contact surface pressure between the shaft 11A and the thrust bearing 14 increases excessively.

In a case where the rotation direction of the cap 16 is a counterclockwise direction, for example, there is a possibility that the thrust bearing 14 is spaced apart from the shaft 11A. As stated above, a relation between the thrust bearing 14 and the shaft 11A changes significantly depending on the rotation direction of the cap 16.

In contrast, the slanting surfaces 16C and 15M according to the present embodiment are configured to generate the rotational force that rotates the cap 16 in the specific direction as the cap 16 is inserted.

Due to the above configuration, even if the cap 16 rotates and the relation between the thrust bearing 14 and the shaft 11A changes as the cap 16 is inserted, such a change remains within what is expected in advance during a designing process. Therefore, according to the present embodiment, performance of the electric actuator 10 can be ensured to fall within what is expected in advance during the designing process.

Furthermore, the slanting surfaces 16C and 15M slant so as to generate the rotational force in the direction to loosen the threaded engagement between the male screw portion 14A and the female screw portion 15E when each elongated protrusion 16B and the corresponding elongated protrusion 15L contact each other.

Due to the above configuration, the electric actuator 10 can ensure that the contact surface pressure between the shaft 11A and the thrust bearing 14 is inhibited from increasing excessively, which can therefore ensure that a significant drive power loss is inhibited from occurring in the contact part between the shaft 11A and the thrust bearing 14.

In the electric actuator 10, as the shaft 11A rotates in the forward direction, a rotational force in the forward direction acts on the thrust bearing 14 and the cap 16. This rotational force is exerted on the elongated protrusions 16B and 15L.

In the present embodiment, as regards the lengths in the extending direction of the elongated protrusion 16B, the length L1 of the first side S1 in the width direction is longer than the length L2 of the second side S2 in the width direction, and the direction from the first end in the width direction towards the second end in the width direction corresponds to the load direction DL.

In other words, the electric actuator 10 provides a configuration in which the rotational force is received at the first ends in the width directions of the elongated protrusions 16B and 15L. Therefore, since a part to receive the rotational force has a greater area, the performance of the electric actuator is stable, as compared with a configuration in which the rotational force is received at the second ends in the width directions of the elongated protrusions 16B and 15L.

### Other Embodiments

The housing 15 according to the above embodiment comprises two or more parts (for example, the housing body 15A and the bearing holder 15B). However, the present disclosure is not limited hereto. For example, the housing 15 may be a one-piece article in which the housing body 15A and the bearing holder 15B are integrally formed.

The electric actuator 10 according to the above embodiment includes the worm 12 as a gear. However, the present disclosure is not limited hereto. For example, the electric actuator 10 may be an electric actuator including a spur gear or a bevel gear as a gear.

The above embodiment provides a configuration in which the slanting surfaces 16C and 15M slant so as to generate the rotational force in the direction to loosen the threaded engagement between the male screw portion 14A and the female screw portion 15E as the cap 16 is fitted. However, the present disclosure is not limited hereto.

For example, there may be provided a configuration in which the slanting surfaces 16C and 15M slant so as to generate a rotational force in a direction to tighten the threaded engagement between the male screw portion 14A and the female screw portion 15E as the cap 16 is fitted.

In the above configuration, the fastening stop current value may be the same value as or a different value from that in the above embodiment. Since this configuration poses a possibility that the rotational force in the tightening direction is generated as the cap 16 is fitted, the fastening stop current value in this configuration is preferably set to a smaller value compared to the fastening stop current value according to the above embodiment.

The above embodiment provides a configuration that satisfies all the requirements (a) to (c). However, the present disclosure is not limited hereto. For example, there may be provided a configuration in which at least one of the requirements (a) to (c) is not satisfied.

In the above embodiment, the electric actuator according to the present disclosure is applied to a vehicle seat of an automobile. However, the present disclosure can be also applied to, for example, seats used in other vehicles such as railway vehicles, ships and boards, and aircrafts, and to stationary seats used in theaters and households.

Furthermore, the present disclosure only has to be consistent with ideas of the present disclosure specified in the above embodiments, and is not limited to the above embodiments. Therefore, the present disclosure may be configured in combination of at least two embodiments of the embodiments described above or may be configured to eliminate any of the illustrated constituent elements or the constituent elements described with reference numerals in the embodiments described above.

What is claimed is:

1. An electric actuator configured to be applied to a vehicle seat and including an electric motor, a shaft configured to be rotatably driven by the electric motor, and a gear fixed to the shaft, the electric actuator comprising:
a radial bearing contacting an outer circumferential surface of the shaft, to thereby rotatably support the shaft;
a thrust bearing contacting an end of the shaft in a direction along a rotation center axis of the shaft, to thereby restrict a displacement of the shaft in the direction along the rotation center axis, the thrust bearing being provided with a male screw portion in a form of a spiral around the rotation center axis as a center axis;
a housing including a housing portion that houses at least the thrust bearing, the housing being provided with a female screw portion threadedly engaged with the male screw portion; and
a cap inserted in the housing portion from an insertion port of the housing portion, the cap having a cylindrical shape, and the cap restricting a rotation of the thrust bearing about the rotation center axis,
the cap being provided with, on an outer circumferential surface thereof, an outer circumferential engagement portion engaged with an engagement target portion provided to an inner circumferential surface of the housing portion,
the cap being provided with, on an inner circumferential surface thereof, an inner circumferential engagement portion engaged with the thrust bearing,
a slanting surface being provided to at least one of a leading end of the outer circumferential engagement portion in an insertion direction of the cap or a part of the engagement target portion adjacent to the insertion port,
the slanting surface slanting to an imaginary line parallel to the rotation center axis, and
the slanting surface being configured to generate a rotational force that rotates the cap in a specific direction about the rotation center axis as the center axis as the cap is inserted along the rotation center axis.

2. The electric actuator according to claim 1, wherein the slanting surface slants to the imaginary line so as to generate a rotational force in a direction to loosen a threaded engagement between the male screw portion and the female screw portion when the leading end of the outer circumferential engagement portion in the insertion direction and the part of the engagement target portion adjacent to the insertion port contact each other.

3. The electric actuator according to claim 2,
wherein the outer circumferential engagement portion and the engagement target portion are configured in a form of a serration or a spline that includes two or more elongated protrusions extending in a direction parallel to the rotation center axis,
wherein the slanting surface is provided at an end in an extending direction of each elongated protrusion,
wherein, between lengths in the extending direction of the each elongated protrusion provided to the cap, a first length at a first end in a width direction is longer than a second length at a second end in the width direction,
wherein a direction from the first end in the width direction towards the second end in the width direction corresponds to a load direction,
wherein a rotation direction of the shaft, at a time when a contact surface pressure between the shaft and the thrust bearing increases, is a forward direction;
wherein the load direction is the forward direction projected onto an imaginary plane containing the rotation center axis; and
wherein the width direction is a direction orthogonal to the extending direction of the each elongated protrusion.

4. The electric actuator according to claim 1,
wherein the thrust bearing has:
a contact end contacting the shaft; and
a non-contact end opposite to the contact end in the direction along the rotation center axis,
wherein the electric actuator further comprises:
a rotation restrictor provided to the inner circumferential engagement portion, the rotation restrictor being configured to restrict the rotation of the thrust bearing with respect to the cap about the rotation center axis; and
a restrictive engagement portion provided to the thrust bearing, the restrictive engagement portion being engaged with the rotation restrictor, and the restrictive engagement portion being provided in an area from the male screw portion to the non-contact end, and
wherein the non-contact end of the thrust bearing is located outside the housing.

5. The electric actuator according to claim 4,
wherein the electric actuator further comprises:
a protrusion provided to a part of the inner circumferential surface of the cap adjacent to the contact end; and
a fitting part provided to a part of the thrust bearing adjacent to the non-contact end, the fitting part allowing the protrusion to be fitted in and engaged with the fitting part, and
wherein, in a state where the protrusion is fitted in the fitting part and the contact end of the thrust bearing and the shaft contact each other, the outer circumferential engagement portion and the engagement target portion are in a non-engaged state.
